(19) United States
(12) Patent Application Publication
(10) Pub. No.: US 2004/0071493 A1
(43) Pub. Date: Apr. 15, 2004

(54) Nail polish remover pen

(76) Inventor: Nicole Hendrix-Stavropoulos, Pittsburgh, PA (US)

Correspondence Address: Richard C. Litman, Litman Law Offices, Ltd., Crystal City Station, P.O. Box 15035, Arlington, VA, 22215-0035, US

(21) Appl. No.: 10/461,508

(22) Filed: Jun. 16, 2003

Related U.S. Application Data
(60) Provisional application No. 60/388,243, filed on Jun. 14, 2002.

(51) Int. Cl. B43K 29/00; B43M 11/06; B43K 8/08

(52) U.S. Cl. 401/205; 401/199; 401/195; 401/202

(57) ABSTRACT

A grooming device especially adapted for removing polish from finger nails. The device is compact, portable and resembles a writing pen in general appearance. A refillable reservoir defines a distal end of the device. A removable closure functions to provide access to the reservoir. The closure also functions as a storage receptacle for extra applicator tips. A felt tip is adapted to absorb polish removal fluid flowing slowly from the reservoir whereby the fluid may easily be applied to the applicator tip and nails for removal of polish therefrom. A removable cap closes the device. The cap is provided with a replaceable nail file/buffer member.

### CROSS-REFERENCE TO RELATED APPLICATION

This application claims the benefit of U.S. Provisional Patent Application Serial No. 60/388,243, filed Jun. 14, 2002.

### BACKGROUND OF THE INVENTION

1. Field of the Invention

The present invention generally relates to grooming appliances. More specifically, the present invention is drawn to device for removing polish from fingernails and the like.

2. Description of Related Art

Sales and usage of personal grooming devices have mushroomed in recent years. It is not uncommon to see an entire television program (infomercial) devoted to the demonstration and sale of grooming devices. Among the most popular devices are those which are utilized to groom the fingernails. Such devices are abundantly represented in the prior art. For example, U.S. Pat. No. 2,804,636 (Sadler) shows a scissor-like tool for holding a sponge. The sponge is saturated with nail polish remover to facilitate application of the remover to the nails. The instant device makes no provision for a buffer or cuticle manipulator.

U.S. Pat. No. 3,341,884 (Pryor), U.S. Pat. No. 4,932,802 (Cantone) and U.S. Pat. No. 5,655,554 (Goldberg) show devices which house both nail polish and nail polish remover. None of the patentees contemplate incorporating a buffer or cuticle manipulator in their device.

U.S. Pat. No. 5,897,262 (Bratby-Carey) discloses a combination nail polish application and removal device, which device includes an emery board attached to the outer surface thereof. The device does not show structure for storing extra polish removal tips.

U.S. Pat. No. 6,155,270 (Samiean) appears to be the most pertinent prior art device. The instant device incorporates a cuticle pusher, a buffer and a replaceable polish remover applicator. The device, however, makes no provision for storing extra applicators therein. Also, the device requires a carrying case for portability.

None of the above inventions and patents, taken either singly or in combination, is seen to disclose a nail polish removal device as will be subsequently described and claimed in the instant invention.

### SUMMARY OF THE INVENTION

The instant invention is a grooming device especially adapted for removing polish from cuticles. The device is compact, portable and resembles a writing pen in general appearance. A refillable reservoir defines a distal end of the device. A removable closure member functions to provide access to the reservoir. The closure member also functions as a storage receptacle. A proximate end of the device terminates in a felt tip. The felt tip is adapted to absorb polish removal fluid flowing slowly from the reservoir, whereby the fluid may easily be applied, via an applicator, to the nails for removal of polish therefrom. Extra applicators are retained in the above-mentioned storage receptacle. A removable cap closes the proximate end of the device and confines the felt tip and applicator therein. The device is provided with a cuticle manipulator. A replaceable nail file/buffer member is disposed on the cap. Although described in relation to fingernails, it is obvious that the invention can be utilized to remove polish from toenails if desired.

Accordingly, it is a principal object of the invention to provide a nail grooming device, which device is adapted to remove polish from the nails.

It is another object of the invention to provide a grooming device, which device is of compact construction.

It is a further object of the invention to provide a grooming device in which nail polish remover fluid and applicators can be easily stored.

Still another object of the invention is to provide a grooming device which incorporates a cuticle manipulator and a nail file/buffer member.

It is an object of the invention to provide improved elements and arrangements thereof in a device for the purposes described which are inexpensive, dependable and fully effective in accomplishing their intended purposes.

These and other objects of the present invention will become readily apparent upon further review of the following specification and drawings.

### BRIEF DESCRIPTION OF THE DRAWINGS

FIG. 1 is an environmental, perspective view of a nail polish remover pen according to the present invention.

FIG. 2 is an exploded, perspective view of a nail polish remover pen according to the present invention.

Similar reference characters denote corresponding features consistently throughout the attached drawings.

### DETAILED DESCRIPTION OF THE PREFERRED EMBODIMENT

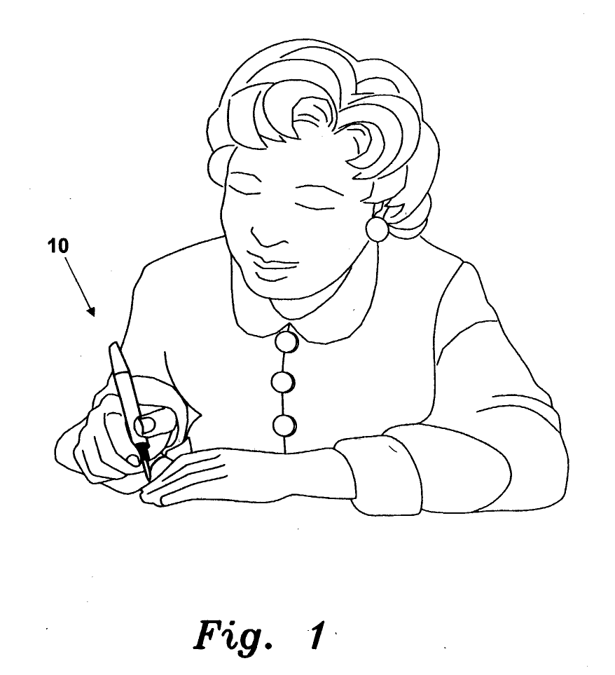

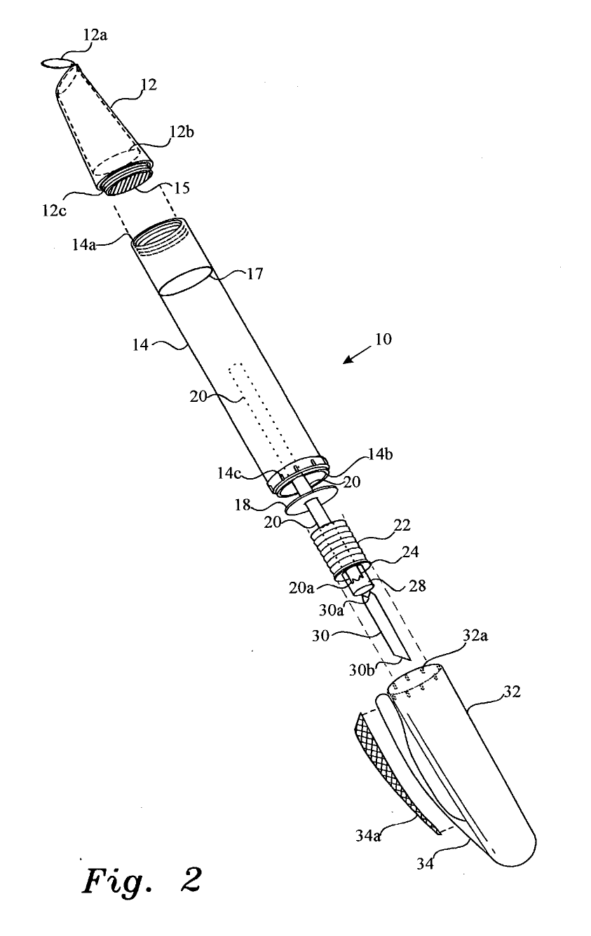

Attention is directed to FIGS. 1 and 2 wherein the nail polish remover pen of the present invention is generally indicated at 10. As best illustrated in FIG. 2, pen 10 includes a hollow member 12 which defines the distal end of the pen. A flip-top 12a is hinged to member 12 so as to provide access to a storage volume in the interior of member 12. When in a closed position, flip-top 12a can also function to manipulate the user's cuticle. Wall 12b closes the bottom of member 12. A hollow cylindrical body 14 forms a middle section of pen 10. Body 14 has open ends 14a, 14b. Body 14 is fabricated from a clear plastic material and is adapted to contain a quantity of nail polish remover fluid therein. The inner surface of end 14a is configured to receive end 12c of member 12. Conventional fastening devices (twist-rivets, screw threads, etc.) can be employed to tighten member 12 to body 14. A rubber seal 15 is utilized to insure a fluid-tight fit. A circumferential line 17 is inscribed on the outer surface of body 14 to indicate the proper refill height for the remover fluid.

End 14b of body member 14 is coupled to an array of devices, which devices are operative to control the flow of remover fluid therethrough. The devices comprise an annular rubber stopper 18, which is used to slow the flow of fluid from the body 14. A felt wick 20 absorbs the fluid and slowly transfuses the same. Wick 20 terminates in a pointed wick tip 20a. Rubber accordion-like member 22 also aids in the transfusion process and functions to keep wick 20 wet. A annular rubber gasket 24 is positioned at the end of member 22 to prevent leakage. Pointed wick tip 20a extends beyond rubber gasket 24. A short, cylindrical, transparent member 28 encompasses tip 20a. An array of indentations 14c, the purpose of which is explained below, is disposed on the outside surface of end 14b.

A felt applicator tip 30 is utilized to apply the remover fluid to the user's nails. Applicator tip 30 is fashioned with a small cavity 30a at its upper end. Applicator tip 30 is adapted to be inserted into member 28 such that wick tip 20a is encompassed in cavity 30a. This arrangement allows the remover fluid to be transfused to the lower end of applicator tip 30. The lower end 30b terminates in a sharply angled point to allow for precise removal of nail polish around the cuticle. It is noted that applicator tip 30 can be quickly and easily removed for storage or disposal when desired. Tips 30 may be stored in cap 12.

A closure cap 32 is provided to enclose the lower end of the pen when not in use. An array of rivets 32a is disposed on the inside lip of cap 32, which rivets 32a are fabricated to slip into indentations 14c so that cap 32 snaps on and fits tightly to prevent accidental leakage. A clip-like member 34 is attached to closure cap 32. The surface of member 34 is fabricated so that a nail file/buffer 34a can be removably attached thereto.

It is to be understood that the present invention is not limited to the sole embodiment described above, but encompasses any and all embodiments within the scope of the following claims.

I claim:

1. A device for removing nail polish comprising:
a hollow body member, said body member having an open first end and an open second end, said hollow body member forming a reservoir for containing nail polish removal fluid;
a closure member removably fastened to said open first end of said body member in a fluid tight manner, said closure member having an inner chamber therein;
a flip-top hinged to said closure member for providing access to said inner chamber;
an array of flow control devices, said array mounted on said open second end of said hollow body; and
an applicator tip removably mounted to said array of flow control devices.

2. A device for removing nail polish according to claim 1, including:
a cap member removably attached to said second open end of said body member, said cap member encompassing said array of flow control devices and said applicator tip.

3. A device for removing nail polish according to claim 1, wherein said array of flow control devices includes a felt wick having a first end which extends into said reservoir and having a second end that terminates in a pointed tip.

4. A device for removing nail polish according to claim 1, wherein said array of flow control devices includes a rubber stopper, an accordion-shaped member and a gasket.

5. A device for removing nail polish according to claim 1, including:
a cap member removably attached to said second open end of said body member, said cap member encompassing said array of flow control devices and said applicator tip; and
a clip attached to said cap member, said clip having an outer surface.

6. A device for removing nail polish according to claim 5, including:
a nail file removably attached to said outer surface of said clip.

7. A device for removing nail polish according to claim 5, including:
a nail buffer removably attached to said outer surface of said clip.

8. A device for removing nail polish comprising:
a hollow body member, said body member having an open first end and an open second end, said hollow body member forming a reservoir for containing nail polish removal fluid;
a closure member removably fastened to said open first end of said body member in a fluid tight manner, said closure member having an inner chamber therein;
a flip-top hinged to said closure member for providing access to said inner chamber;
an array of flow control devices, said array mounted on said open second end of said hollow body, said array including a felt wick having a first end which extends into said reservoir, said felt wick having a second end that terminates in a pointed tip; and
an applicator tip removably mounted to said to said felt wick.

9. A device for removing nail polish according to claim 8, wherein said applicator tip has a proximate end and a distal end and including a small cavity disposed in said distal end.

10. A device for removing nail polish according to claim 9, wherein said second end of said felt wick is disposed within said small cavity.

11. A device for removing nail polish according to claim 10, wherein said array of flow control devices also includes a rubber stopper, an accordion-shaped member and a gasket.

12. A device for removing nail polish according to claim 11 including:
a cap member removably attached to said second open end of said body member, said cap member encompassing said array of flow control devices and said applicator tip; and
a clip attached to said cap member, said clip having an outer surface.

13. A device for removing nail polish according to claim 12, wherein said hollow body member is fabricated from a clear plastic material.

14. A device for removing nail polish according to claim 12 including:
a nail file removably attached to said outer surface of said clip.

15. A device for removing nail polish according to claim 12 including:
a nail buffer removably attached to said outer surface of said clip.
